(19) United States
(12) Patent Application Publication
(10) Pub. No.: US 2008/0206567 A1
(43) Pub. Date: Aug. 28, 2008

(54) Plastic Conductive Particles and Manufacturing Method Thereof

(75) Inventors: Byung Hoon Min, Daejun (KR); Kyung Heum Kim, Daejun (KR); Seung Bum Kim, Daejun (KR); Sung Soo Lee, Daejun (KR); Kyoung Bae Park, Ulsan (KR); Nam Gyol Kim, Ulsan (KR); Byoung Jae Yoo, Ulsan (KR)

Correspondence Address: D. PETER HOCHBERG CO. L.P.A., 1940 EAST 6TH STREET, CLEVELAND, OH, 44114, US

(73) Assignee: Dongbu Hitek Co., Ltd., Seoul (KR)

(21) Appl. No.: 11/794,634

(22) PCT Filed: Dec. 28, 2005
(86) PCT No.: PCT/KR05/04602

§ 371 Date: Oct. 9, 2007

(30) Foreign Application Priority Data
Dec. 30, 2004 (KR) 10-2004-0116657

(51) Int. Cl. B05D 5/12; B32B 15/02; B32B 37/02; C25D 5/00; C25D 3/12; B32B 37/24

(52) U.S. Cl. 428/404; 428/403; 427/214; 427/532

(57) ABSTRACT

Plastic conductive particles having an outer diameter of 2.5 μm˜1 mm obtained by sequentially plating a 0.1˜10 μm thick metal plating layer and a 1˜100 μm thick Pb solder layer or a Pb-free solder layer on plastic core beads having a high elastic modulus of compression, and a method of manufacturing thereof. The method of manufacturing the plastic conductive particles includes preparing plastic core beads having excellent thermal properties and a high elastic modulus of compression, etching surfaces of the plastic core beads for surface treatment thereof, forming a metal plating layer via electroless plating to improve adhesion between the bead surface and the metal plating layer, and then forming a solder layer such that a sealed hexagonal barrel is immersed in an electroplating solution and then an electroplating process is conducted using a mesh barrel rotating 360° at 6˜10 rpm or a mesh barrel having a structure in which one surface of a conventional sealed hexagonal barrel is open, and rotating 200° in right and left directions at 1˜5 rpm, to manufacture plastic conductive particles having a size of 1 mm or less. The plastic conductive particles of this invention enable the maintenance of packaging gaps, and thus can be applied to IC packaging, LCD packaging and other conductive materials.

### CROSS-REFERENCE TO RELATED APPLICATIONS

This application is a National Stage application of International Application No. PCT/KR2005/004602, filed of Dec. 28, 2005 , which claims priority of Korean application number 10-2004-0116657, filed on Dec. 30, 2004.

### BACKGROUND OF THE INVENTION

1. Field of the Invention

The present invention relates to plastic conductive particles and a manufacturing method thereof. More particularly, the present invention relates to an improved method of manufacturing plastic conductive particles having an outer diameter of 1 mm or less, comprising preparing plastic core beads having a high elastic modulus of compression of 400˜550 kgf/mm², which are then subjected to a pretreatment process before electroplating and then to an electroplating process using a mesh barrel rotating 360° at 6˜10 rpm or a mesh barrel rotating 200° in right and left dimensions at 1˜5 rpm, thus manufacturing plastic conductive particles.

2. Description of the Prior Art

In order to correct ICs or LSIs to an electrical circuit board, methods of soldering individual pins on a printed wire board have been used to date. However, such methods have low production efficiency and are unsuitable for realizing high-density packaging.

Thus, with the aim of improving connection reliability, BGA (ball grid array) techniques for connecting chips to the substrate using spherical pieces of solder, called solder balls, have been developed. According to this technique, the substrate, chips, and solder balls mounted on the substrate are connected via a melting process at high temperature, thereby completing circuits on the substrate while satisfying high productivity and high connection reliability. However, when the metal is used, cracking is easily caused due to the inherent properties of metal. In addition, as the size of the metal bead is decreased, a preparation process is difficult to conduct, and an elastic modulus is low, and thus, upon evaluation of connection reliability, packaging gaps between the IC Chips and PCB Substrates electronic apparatus are reduced depending on the progression of thermal cycles, leading to lowered thermal stress buffer efficiency.

Further, according to the recent trend toward multilayered substrates, it is difficult to maintain the gaps between the IC Chips and PCB Substrates. In addition, the multilayered substrate entails extension or expansion and contraction of the substrate itself due to changes in the external environment. Therefore, when such force is applied upon the connection between the IC Chips and PCB Substrates, wires may undesirably break.

Because the use of Pb for the solder balls has recently been restricted, thorough research into methods of decreasing the amount of Pb or using a Pb-free material is being conducted.

As a preferable means for solving such problems, spherical plastic beads having a relatively high elastic modulus are used instead of conductive metal beads, thus connection reliability is expected to increase.

As such plastic beads, spherical plastic beads having an outer diameter of 1 mm or more have been mass produced via electroplating using a rack type or acryl barrel.

However, in the case of plastic conductive particles for use in small electric and electronic parts having a size of 1 mm or less, they have such low densities that they float on the plating solution, resulting in insufficient electroplating efficiency. Thus, it is impossible to electroplate such particles via a conventional acryl barrel-type electroplating process using a dangler. Also, even though electroplating is conducted, circulation between the plating solutions inside and outside the barrel is not efficiently realized, therefore the surfs of the electroplated plastic conductive particles are rough and a solder layer cannot be electroplated to a thickness of 8 μm or more.

Leading to the present invention, intensive and thorough effort to manufacture plastic conductive particles having an outer diameter of 1 mm or less, the present invention, aiming to avoid the problems encountered in the related art, resulted in plastic conductive particles provided by preparing plastic core beads having a high elastic modulus of compression, pretreating the surfaces of the core beads, forming a metal plating layer on the pretreated bead surface via electroless plating, and then forming a solder layer to a thickness of 1˜100 μm via electroplating using a mesh barrel rotating 360° at 6˜10 rpm or a mesh barrel rotating 200° in right and left directions at 1˜5 rpm, such that the plastic conductive particles enable the maintenance of packaging gaps.

### SUMMARY OF THE PRESENT INVENTION

Accordingly, an object of the present invention is to provide plastic conductive particles having an outer diameter of 2.5 μm˜1 mm obtained by sequentially plating a metal plating layer and a Pb solder layer or a Pb-free solder layer on plastic core beads having a high elastic modulus of compression.

Another object of the present invention is to provide a pretreatment method before electroplating to manufacture the plastic conductive particles having an outer diameter of 1 mm or less.

A further object of the present invention is to provide a method of manufacturing the plastic conductive particles having an outer diameter of 1 mm or less via electroplating using a mesh barrel rotating 360° at 6˜10 rpm or a mesh barrel rotating 200° in right and left directions at 1˜5 rpm.

The present invention provides spherical plastic conductive particles, comprising plastic core beads having a high elastic modulus of compression of 400˜550 kgf/mm²; a nickel plating layer formed to a thickness of 0.1˜10 μm on the beads; and a solder layer formed to a thickness of 1˜100 μm on the nickel plating layer using any one selected from the group consisting of Sn/Pb, Sn/Ag, Sn, Sn/Cu, Sn/n, and Sn/Bi.

The plastic conductive particles may further comprise a copper plating layer formed to a thickness of 0.1˜10 μm on the nickel plating layer to provide a plurality of metal plating layers.

The plastic conductive particles may be in spherical form and may have an outer diameter of 2.5 μm to 1 mm.

The plastic core beads may be prepared by intercalating a polymerizable monomer into a layered structure of hydrophobized clay minerals to prepare a nanoclay composite substituted with the polymerizable monomer and then uniformly dispersing the nanoclay composite using a suspension polymerization process. Preferably, the plastic core beads are polystyrene particles in which the nanoclay composite is uniformly dispersed. The plastic core beads have a 5% thermal decomposition temperature of 250˜350° C. while a glass transition temperature (Tg) or a melting temperature is not detected in the above temperature range, and a high elastic modulus compression of 400˜550 kgf/mm².

Preferably, the plastic conductive particles of the present invention have an outer diameter of 10 μm to 1 mm, comprising the plastic core beads having a high elastic modulus of compression of 400˜550 kgf/mm²; the nickel plating layer formed to a thickness of 0.1˜10 μm on the beads; and the solder layer formed to a thickness of 1˜100 μm including 60˜70% Sn/30˜40% Pb on the nickel plating layer.

The plastic conductive particles may further comprise a copper plating layer formed to a thickness of 0.1˜10 μm on the nickel plating layer.

In addition, the plastic conductive particles of the present invention may have an outer diameter of 10 μm to 1 mm, comprising the plastic core beads having a high elastic modulus of compression of 400˜550 kgf/mm²; the nickel plating layer formed to a thickness of 0.1˜10 μm on the beads; and the solder layer formed to a thickness of 1˜100 μm including 96˜97% Sn/3.0˜4.0% Ag on the nickel plating layer.

The plastic conductive particles may further comprise a copper plating layer formed to a thickness of 0.1˜10 μm on the nickel plating layer.

In addition, the present invention provides a method of manufacturing plastic conductive particles, comprising 1) preparing plastic core beads in which a nanoclay composite is uniformly dispersed, with a high elastic modulus of compression, 2) etching the surface of the plastic core beads for surface treatment thereof; 3) adsorbing Sn and Pd to the surface of the plastic core beads using a pretreatment solution containing SnCl₂ and a pretreatment solution containing PdCl₂, thus pretreating the plastic core beads; 4) forming a nickel plating layer to a thickness of 0.1˜10 μm using a nickel plating solution on the adsorbed bead surface, thus obtaining plastic beads; 5) mixing the plastic beads with 0.1 mm˜3.0 cm sized steel balls at a weight ratio of 1:2 to 1:20; and 6) electroplating the mixed plastic beads using an electroplating solution including any one selected from the group consisting of Sn/Pb, Sn/Ag, Sn, Sn/Cu, Sn/Zn, and Sn/Bi, to form a solder layer.

The method may further comprise forming a 0.1˜10 μm thick copper plating layer on the nickel plating layer using a copper plating solution.

In the method, step 2) may be conducted by immersing the plastic core beads in an etching solution composed mainly of 50˜300 g/L of chromic acid and 10˜100 g/L of potassium permanganate and then etching the surfaces of the beads at 60° C. for 1˜2 hours for surface treatment.

The pretreatment solutions used in step 3) are preferably a pretreatment solution obtained by adding SnCl₂ to a composition consisting of hydrochloric acid, water and a surfactant, and a pretreatment solution obtained by adding PdCl₂ to the above composition.

The nickel plating layer of step 4) may be formed via electroless plating using a nickel plating solution comprising nickel sulfate, sodium acetate, maleic acid, sodium phosphite as a reducing agent, sodium thiosulfate and lead acetate as stabilizers, and triton X-100 as a surfactant

In addition, the copper plating layer may be formed via electroless plating using the copper plating solution comprising copper sulfate, EDTA, 2,2-bipyridine, formaldehyde as a reducing agent, and PEG-1000 as a surfactant.

The solder layer of step 6) may be formed by electroplating the plastic beads having the metal plating layer using the plating solution including any one selected from the group consisting of Sn/Pb, Sn/Ag, Sn, Sn/Cu, Sn/Zn, and Sn/Bi. Preferably, the solder layer is a Sn/Pb alloy layer comprising 70% Sn and 30˜40% Pb or a Sn/Ag alloy layer comprising 96˜97% Sn and 3.0˜4.0% Ag.

In the method of manufacturing the plastic conductive particles of the present invention, the solder layer may be prepared via electroplating using a mesh barrel rotating 360° at 6˜10 rpm or a mesh barrel rotating 200° in right and left directions at 1˜5 rpm. Specifically, using a cathode dangler having a bar-type cathode wire for improvement of electroplating, instead of a conventional lead wire-type cathode wire, the plating object is dispersed in a mesh barrel having the form of a sealed hexagonal barrel, such a hexagonal barrel is immersed in the electroplating solution, and then an electroplating process using the mesh barrel rotating 360° at 6˜10 rpm is conducted. Alternatively, an improved electroplating process using a mesh barrel rotating 200° in right and left directions at 1˜5 rpm is conducted, provided that the mesh barrel has a structure in which one surface of a conventional sealed hexagonal barrel is open to efficiently circulate the plating solution, and then the plating solution is introduced into the barrel. As such, the electroplating process is conducted under conditions of a cathode current density of 0.1˜10 A/dm², a plating solution temperature of 10˜30° C., a barrel rotation speed of 1˜10 rpm, and a plating speed of 0.2˜0.8 μm/min at a cathode current density of 1 A/dm².

[Advantageous Effects]

First, the present invention provides novel plastic core beads having a nanoclay composite uniformly dispersed therein, with excellent thermal properties and a high elastic modulus of compression.

Second, the present invention provides spherical plastic conductive particles having an outer diameter of 1 mm or less, suitable for use in IC packaging of electronic apparatus, LCD packaging, or other conductive materials.

Third, the present invention provides a method of manufacturing the plastic conductive particles having an outer diameter of 1 mm or less, comprising surface treating the core beads using an etching solution before electroplating, mixing the obtained beads with 0.1 mm˜3.0 cm sized steel balls at a predetermined ratio to solve the problem of low density of the beads, and then electroplating the beads.

Fourth, the present invention provides a method of manufacturing the plastic conductive particles having an outer diameter of 1 mm or less via an electroplating process using a mesh barrel rotating 360° at 6˜10 rpm or a mesh barrel rotating 200° in right and left directions at 1˜5 rpm.

### BRIEF DESCRIPTION OF THE DRAWINGS

FIG. 1 is an SEM image showing the etched surfaces of plastic core beads of the present invention;

FIG. 2 is an enlarged image of the beads of FIG. 1;

FIG. 3 is a view showing a lead wire-type cathode wire provided for a conventional cathode dangler;

FIG. 4 is a view showing a bar-type cathode wire provided for a cathode dangler of the present invention;

FIG. 5 is a side view showing an electroplating apparatus rotating 360° at 6˜10 rpm as an illustrative example for use in an electroplating process using a mesh barrel;

FIG. 6 is a front view of the electroplating apparatus of FIG. 5;

FIG. 7 is a side view showing an electroplating apparatus rotating 200° in right and left directions at 1˜5 rpm, as another illustrative example for use in an electroplating process using a mesh barrel;

FIG. 8 is a front view of the electroplating apparatus of FIG. 7;

FIG. 9 is an SEM image showing the surface of plastic conductive particles having a Sn/3.5% Ag solder layer, according to the present invention;

FIG. 10 is an SEM image showing the plating thickness of the particles of FIG. 9;

FIG. 11 is a result of TGA (Thermogravimetric Analysis) of the plastic core beads manufactured in Example 1 of the present invention; and

FIG. 12 is a result of TGA of the plastic core beads manufactured in Comparative Example 1.

### DETAILED DESCRIPTION OF THE PRESENT INVENTION

[Best Mode]

Hereinafter, a detailed description will be given of the present invention.

1. Manufacture of Plastic Core Beads

The plastic core beads of the present invention are manufactured using a first step of intercalating a polymerizable monomer into a layered structure of hydrophobized clay minerals to prepare a nanoclay composite substituted with the polymerizable monomer and a second step of manufacturing plastic core beads in which the nanoclay composite is uniformly dispersed using a suspension polymerization process, having a high elastic modulus of compression.

As such, the process of manufacturing the plastic core beads includes emulsion polymerization, dispersion polymerization, or seed polymerization, in addition to suspension polymerization

Step 1: Preparation of Nanoclay Composite

The polymerizable monomer is dissolved in a solvent to obtain a polymerizable monomer solution, which is then added with 0.1˜50 parts by weight of hydrophobized clay minerals and 0.01˜2.0 parts by weight of a polymerization initiator, based on 100 parts by weight of the polymerizable monomer, thus preparing a nanoclay composite substituted with the polymerizable monomer.

The polymerizable monomer used in the present invention is not particularly limited as long as it is used for radical polymerization, and is selected from the group consisting of styrene, α-methylstyrene, methylmethacrylate, vinylester, acrylic acid, methacrylic acid, N-vinylpyrrolidone, vinylidenefluoride, tetrafluoroethylene, trichlorofluoroethlyene, and mixtures thereof. Preferably, styrene or methylmethacrylate is used.

The hydrophobized clay mineral of the present invention is obtained in a manner such that natural clay mineral, which is hydrophilic, is selected, and a naturally generated cation present in the clay is substituted using a surfactant, thus modifying such a hydrophilic clay material into a hydrophobic clay mineral. As such, the natural clay mineral is selected from the group consisting of montmorillonite, smectite, phyllosilicate, saponite, beidellite, montronite, hectorite, stevensite, and mixtures thereof. Further, a surfactant necessary for modification of natural clay is selected from the group consisting of dimethyl dihydrogenated tallow alkyl ammonium chloride, dimethyl hydrogenated tallow alkyl benzyl ammonium chloride, dimethyl 2-ethylhexyl hydrogenated ammonium chloride, and trimethyl hydrogenated tallow alkyl ammonium chloride. In the examples of the present invention, hydrophobized montmorilonite is preferably used. In addition, the hydrophobized clay mineral is used in an amount of 0.1˜50 parts by weight, and preferably 1˜10 parts by weight, based on 100 parts by weight of the polymerizable monomer. As such, if the hydrophobized clay mineral is used in an amount less than 0.1 parts by weight, the resultant nanoclay composite has too low a concentration. On the other hand, if the above amount exceeds 50 parts by weight, the resultant nanoclay composite suffers because the polymerizable monomer is insufficiently intercalated into the layered structure of the clay. In both cases, there is no improvement in the elastic modulus of compression of the manufactured plastic core beads.

As the polymerization initiator, a symmetric functional azo compound, symmetric polyfunctional peroxide, asymmetric polyfunctional peroxide, and mixtures thereof may be used. Specifically, useful are mixtures of at least two selected from the group consisting of benzoyl peroxide, di-t-butylcumyl peroxide, dicumyl peroxide, 2,5-dimethyl-2,5-di(t-butylperoxy)hexane, octanoyl peroxide, decanoyl peroxide, lauroyl peroxide, stearoyl peroxide, 3,3,5-trimethylhexanoyl peroxide, t-butylperoxyacetate, t-butylperoxy isobutyrate, t-butylperoxy(2-ethylhexanoate), t-butylperoxy-3,3,5-trimethylhexanoate, t-butylperoxylaurate, t-butylperbenzoate, di-t-butylperoxyisophthalate, 2,5-dimethyl-2,5-di(benzoylperoxy)hexane, t-butylperoxyisopropylcarbonate, 2.2′-azobisisobutyronitrile, 2.2′-azobis-2,4-dimethylvaleronitrile, 2-2′-azobis-2-methylisobutyronitrile, and azobis-2-methylpropionitnile. More preferably, a mixture comprising 2-2′-azobisisobutyronitrile, benzoyl peroxide, and t-butylperoxy-3,3,5-trimethylhexanoate is used.

The polymerization initiator is used in an amount of 0.01˜2.0 parts by weight, based on 100 parts by weight of the polymerizable monomer. If the polymerization initiator is used in an amount less than 0.01 parts by weight, the polymerization reaction of the monomer is difficult to effectively conduct in the layered structure of the clay, and the resultant nanoclay composite is disadvantageous because the layered structure of the clay is not spaced by a predetermined sufficient interval. On the other hand, if the above amount exceeds 2.0 parts by weight, a strong explosive exothermic reaction may occur at any moment during the progression of the reaction

The solvent is soluble to the polymerizable monomer but should be insoluble to the polymer, and is preferably selected from the group consisting of methanol, ethanol, propanol, butanol, cyclohexanol, acetone, methylethylketone, cyclohexanone, and acetonitrile. More preferably, acetonitrile is used as the solvent.

Step 2: Manufacture of Plastic Core Beads having High Elastic Modulus of Compression

0.01˜10.0 parts by weight of a dispersion stabilizer are dissolved in 100 parts by weight of ion exchange water to pre a first solution Separately, 0.1˜50 parts by weight of the nanoclay composite prepared in step 1, 1˜50 parts by weight of a crosslinkable monomer and 0.01˜2.0 parts by weight of the polymerization initiator are added to 100 parts by weight of the polymerizable monomer to prepare a second solution Then, the first solution and the second solution are mixed together and undergo suspension polymerization, thus manufacturing plastic core beads.

As such, the crosslinkable monomer, which is a polyfunctional vinyl-based crosslinkable monomer having at least two double bonds, is selected from the group consisting of divinylbenzene, ethyleneglycoldimethacrylate, diethylglycolmethacrylate, triethyleneglycolmetcrylate, trimethylenepropane methacrylate, 1,3-butanediolmethrylate, 1,6-hexanedioldimethaciylate and arylacrylate. Preferably, divinylbenzene is used. Such a crosslinkable monomer is used in an amount of 1.0˜50 parts by weight, and preferably 10˜30 parts by weight, based on 100 parts by weight of the polymerizable monomer. If the amount of crosslinkable monomer is less than 1.0 part by weight, considerable portions of polymer chains remain in the state of not being crosslinked, and thus the inherent temperature characteristics of a homopolymer, such as the glass transition temperature (Tg) and melting temperature, are exhibited, resulting in deformed plastic core beads. On the other hand, if the above amount exceeds 50 parts by weight, the resultant plastic core beads are undesirably unresistant to repeated impact due to the imbalance between stiffness and elasticity thereof.

The dispersion stabilizer is used for stabilization of dispersion upon suspension polymerization and is selected from the group consisting of tricalcium phosphate, trisodium phosphate, polyvinylalcohol, polyvinylpyrolidone, cellulose (methylcellulose, ethylcellulose, hydroxypropylcellulose), polyvinylalcohol-co-vinylacetate, and mixtures thereof.

The polymerizable monomer and polymerization initiator are the same as those used in step 1.

In the present invention, the plastic core beads have an outer diameter of 2.5 μm˜1 mm, and have thermal properties having a 5% decomposition tempure of 330° C. or more according to TGA, in which Tg is not detected upon analysis using a DSC (Differential scanning calorimeter), and a high elastic modulus of compression of 400˜550 kgf/mm².

2. Plastic Conductive Particles

The present invention provides plastic conductive particles comprising plastic core beads having a 5% thermal decomposition temperature of 250˜350° C. while Tg or a melting temperature is not detected in the above temperature range, and a high elastic modulus of compression of 400˜550 kgf/mm²; a nickel plating layer formed to a thickness of 0.1˜10 μm on the beads; and a solder layer formed to a thickness of 1˜100 μm on the nickel plating layer using any one selected from the group consisting of Sn/Pb, Sn/Ag, Sn, Sn/Cu, Sn/Zn and Sn/Bi.

In addition, the plastic conductive particles of the present invention further comprise a 0.1˜10 μm thick copper plating layer formed on the nickel plating layer to provide a plurality of metal plating layers.

As such, the plastic conductive particles are spherical and have an outer diameter of 2.5 μm to 1 mm, and preferably 10 μm to 1000 μm. Specifically, the outer diameter of the plastic conductive particles is 45 μm, 100 μm, 250 μm, 300 μm, 350 μm, 450 μm, 500 μm, 760 μm, 1000 μm±20 μm.

According to a first embodiment of the present invention, there are provided plastic conductive particles having an outer diameter of 740˜780 μm, and preferably 744˜776 μm, comprising plastic core beads having a 5% thermal decomposition temperate of 250˜350° C. while Tg or a melting temperature is not detected in the above temperature range, and a high elastic modulus of compression of 400˜550 kgf/mm²; a nickel plating layer formed to a thickness of 1˜3 μm on the beads; and a solder layer formed to a thickness of 80˜100 μm, including 60˜70% Sn/30˜40% Pb or 96˜97% Sn/3.0˜4.0% Ag, on the nickel plating layer.

In addition, the plastic conductive particles further comprise a 13 μm thick copper plating layer formed on the nickel plating layer to provide nickel/copper plating layers. Thus, it is readily understood that the solder layer is formed on the nickel plating layer or nickel/copper plating layers.

According to a second embodiment of the present invention, there are provided plastic conductive particles having an outer diameter of 430˜470 μm, and preferably 434˜466 μm, comprising plastic core beads having a 5% thermal decomposition temperature of 250˜350° C. while Tg or a melting temperature is not detected in the above temperature range, and a high elastic modulus of compression of 400˜550 kgf/mm²; a nickel plating layer formed to a thickness of 4˜6 μm on the beads; and a solder layer formed to a thickness of 45˜80 μm, including 60˜70% Sn/30˜40% Pb or 96˜97% Sn/3.0˜4.0% Ag, on the nickel plating layer.

In addition, the plastic conductive particles fiuther comprise a 4·6 μm thick copper plating layer formed on the nickel plating layer to provide nickel/copper plating layers. Thus, the solder layer may be formed on the nickel plating layer or nickel/copper plating layers.

According to a third embodiment of the present invention, there are provided plastic conductive particles having an outer diameter of 280˜320 μm, and preferably 284˜316 μm, comprising plastic core beads having a 5% thermal decomposition temperature of 250˜350° C. while Tg or a melting temperature is not detected in the above temperature range, and a high elastic modulus of compression of 400˜550 kgf/mm²; a nickel plating layer formed to a thickness of 7˜8 μm on the beads; and a solder layer formed to a thickness of 25˜45 μm, including 60˜700% Sn/30˜40% Pb or 96˜97% Sn/3.0˜4.0% Ag, on the nickel plating layer.

In addition, the plastic conductive particles fer comprise a 7˜8 μm thick copper plating layer formed on the nickel plating layer to provide nickel/copper plating layers. Thus, the solder layer may be formed on the nickel plating layer or nickel/copper plating layers.

According to a fourth embodiment of the present invention, there are provided plastic conductive particles having an outer diameter of 25˜65 μm, and preferably 35˜55 μm, comprising plastic core beads having a 5% thermal decomposition temperature of 250˜350° C. while Tg or a melting temperature is not detected in the above temperature range, and a high elastic modulus of compression of 400˜550 kgf/mm²; a nickel plating layer formed to a thickness of 9˜10 μm on the beads; and a solder layer formed to a thickness of 5˜10 μm, including 60˜70% Sn/30˜40% Pb or 96˜97% Sn/3.0˜4.00 Ag, on the nickel plating layer.

In addition, the plastic conductive particles further comprise a 9˜10 μm thick copper plating layer formed on the nickel plating layer to provide nickel/copper plating layers. Thus, the solder layer may be formed on the nickel plating layer or nickel/copper plating layers.

3. Method of Manufacturing Plastic Conductive Particles

The present invention provides a method of manufacturing plastic conductive particles. Specifically, the manufacturing method comprises steps of 1) manufacturing plastic core beads in which a nanoclay composite is uniformly dispersed, having a high elastic modulus of compression, 2) etching the surface of the plastic core beads for surface treatment thereof, 3) adsorbing Sn and Pd onto the surface of the plastic core beads using a pretreatment solution containing SnCl₂ and a pretreatment solution containing PdCl₂, 4) forming a 0.1˜10 μm thick nickel plating layer on the adsorptive surface of the plastic core beads using a nickel plating solution, thus obtaining plastic beads, 5) mixing the plastic beads with 0.1 mm˜3.0 cm sized steel balls at a weight ratio of 1:2 to 1:20, and 6) electroplating the mixed plastic beads using a plating solution having any one selected from the group consisting of Sn/Pb, Sn/Ag, Sn, Sn/Cu, Sn/Zn, and Sn/Bi, to form a solder layer.

The method of manufacturing the plastic conductive particles of the present invention further comprises a step of forming a 0.1˜10 μm thick copper plating layer on the nickel plating layer using a copper plating solution.

In the manufacturing method of the present invention, step 2), which is used to increase adhesion between the plastic core beads and the metal plating layer, is conducted in a manner such that the plastic core beads are immersed in an etching solution composed mainly of 50˜300 g/L of chromic acid and 10˜100 g/L of potassium permanganate and then etched at 60·90° C. for 1˜2 hours for surface treatment thereof. As the concentration and temperature of the etching solution are increased, an etching effect is improved. Thereby, plastic beads having high adhesion between the plastic core beads and the metal plating layer of 1200 l/cm² or more can be manufactured.

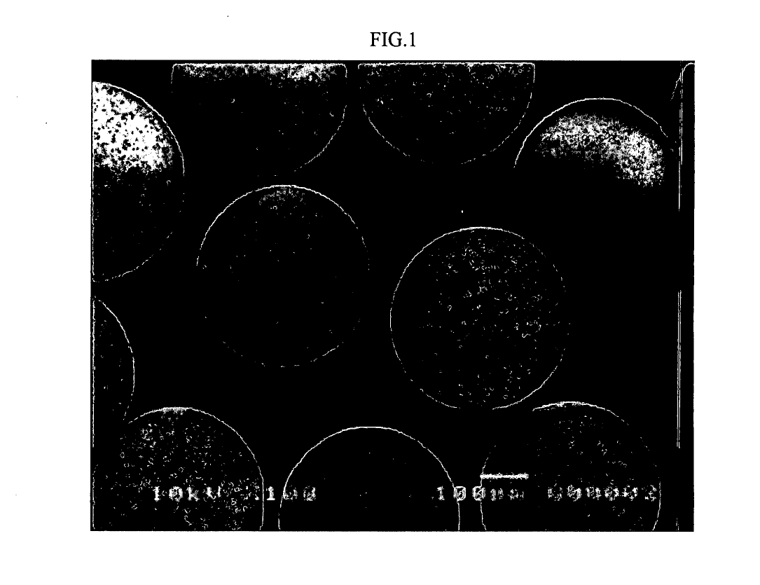

FIG. 1 is an SEM image showing the surfaces of the beads after surface etching comprised in the process of manufacturing the plastic conductive particles of the present invention. As shown in this drawing, the plastic core beads can be confirmed to have a spherical shape, a uniform size, and a surface roughness.

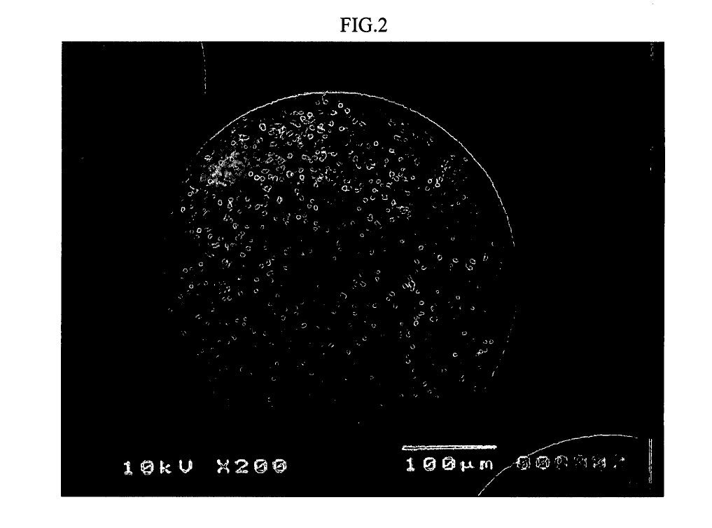

FIG. 2 is an enlarged image of the beads of FIG. 1, in which di spherical plastic core beads have an average outer diameter of 284˜314 μm and a surface of concavo-convex pattern.

Subsequently, in step 3), the surface of the beads is treated with the pretreatment solution obtained by adding SnCl₂ to a composition consisting of hydrochlioric acid, water and a surfactant and the pretreatment solution obtained by adding PdCl₂ to the above composition, whereby Sn and Pd are adsorbed onto the beads surface. In such a case, the surfactant added to the pretreatment solution acts to prepare a metal plating layer having a dense plating texture and a uniform thickness, thus manufacturing plastic beads having shiny surfaces. As the preferable surfactant, triton X-100 is used.

In step 4), the nickel plating layer is formed through electroless plating using a nickel plating solution comprising nickel sulfate, sodium acetate, maleic acid, sodium phosphite serving as a reducing agent, sodium thiosulfate and lead acetate serving as stabilizers, and triton X-100 serving as a surfactant. As such, the formed nickel plating layer is 0.1˜10 μm thick, and preferably 4˜8 μm thick.

Further, the copper plating layer is formed through electroless plating using a copper plating solution comprising copper sulfate, EDTA, 2,2-bipyridine, formaldehyde serving as a reducing agent, and PEG-1000 serving as a surfactant. Preferably, the copper plating layer has a thickness of 4˜8 μm.

In step 5), the resultant plastic beads having an outer diameter of 0.7 mm or less have a low density and thus undesirably float on the plating solution. In order to solve this problem, the plastic beads are mixed with steel balls having a size of 0.1 mm˜3.0 cm at a weight ratio of 1:2 to 1:20.

In step 6), since the plastic beads of the present invention have a low density due to their spherical shape and diameter of 0.7 mm or less, a typical electroplating process is difficult to apply. In order to solve this problem, an electroplating process using a mesh barrel, which is an improvement over a conventional electroplating process, is used.

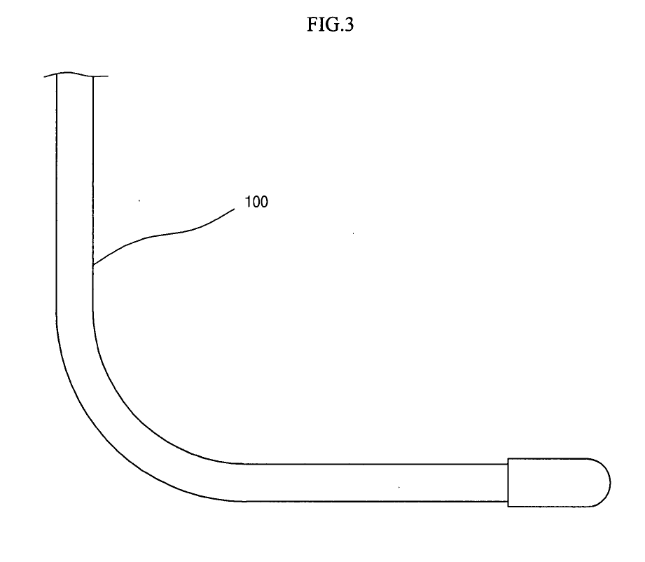

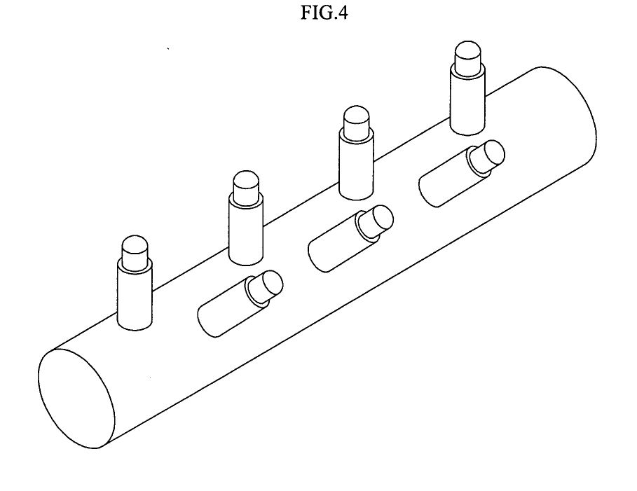

Specifically, using a cathode dangler having a bar-type cathode wire (FIG. 4) for improvement of electroplating, instead of a conventional lead wire-type cathode wire (FIG. 3), the plating object is dispersed in the mesh barrel, whereby the range of current distribution is widened, thus conducting electroplating.

As in FIG. 3, when using a cathode dangler having a lead wire-type cathode wire (100) formed of brass with a thickness of 8 mm (8SQ), actual current of about 20 A flows. As such, the actual current amount is calculated by multiplying the thickness of wire by 2 to 2.5.

In FIG. 4, in which the bar-type cathode wire is used, four electrodes protrude downwards (downward dangler 4EA) and three electrodes protrude at 45° (3EA at 45°). Such a shape functions to uniformly mix the plastic conductive particles of the present invention and to realize uniform current distribution between the plating material and the conductive media having a small particle size inside the mesh barrel.

In the case of bar-type cathode danglers of FIG. 4, even when the electric wire formed of brass is 6 mm thick, actual current amount (6 mm×2.5×7 (number of danglers)=105 A) is higher than a conventional cathode dangler.

Then, as an illustrative example of an electroplating process using a mesh barrel, an electroplating process is conducted using a mesh barrel rotating 360° at 6˜10 rpm. In addition, as another illustrative example of an electroplating process using a mesh barrel, an electroplating process may be carried out using a mesh barrel rotating 200° in right and left directions at 1˜5 rpm.

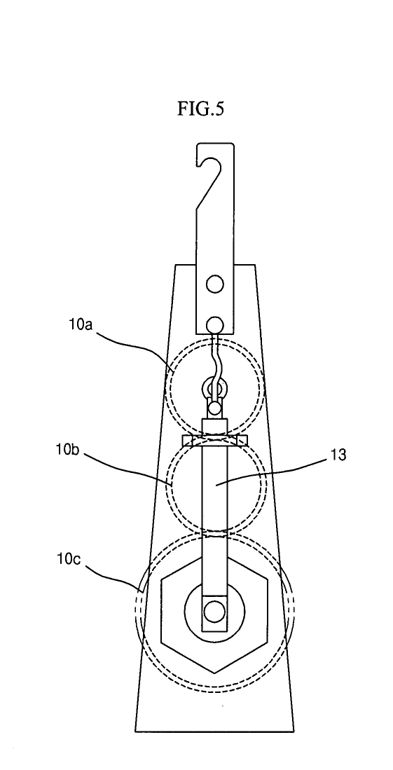

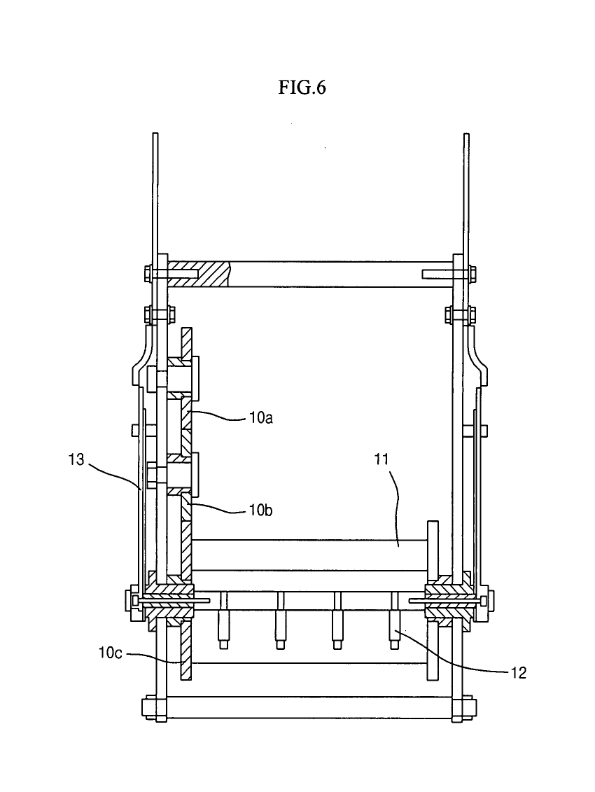

FIG. 5 is a side view showing an electroplating apparatus for use in an electroplating process using a mesh barrel rotating 360°, and FIG. 6 is a front view of the above apparatus.

According to the electroplating process using a mesh barrel, a gear is attached to a shaft, and while the shaft connected to a motor is rotated, a barrel combined with a driving gear (10a) begins to rotate, and then driving gears (10b, 10c) are driven and rotated in series. By such rotation driving, a mesh barrel (11) having the form of a sealed hexagonal barrel provided with bar-type danglers (12) is immersed in an electroplating solution and is then rotated in the range of 360° at 6˜10 rpm, thus conducting the electroplating process. As such, a cathode booth bar (13) is made of a copper plate and is combined with the bar-type dangler (12) in the barrel for current flow. In addition, when the cathode booth bar (13) attached to the barrel has a size of 35 mm×5 mm×2.5, current of 437 A may flow.

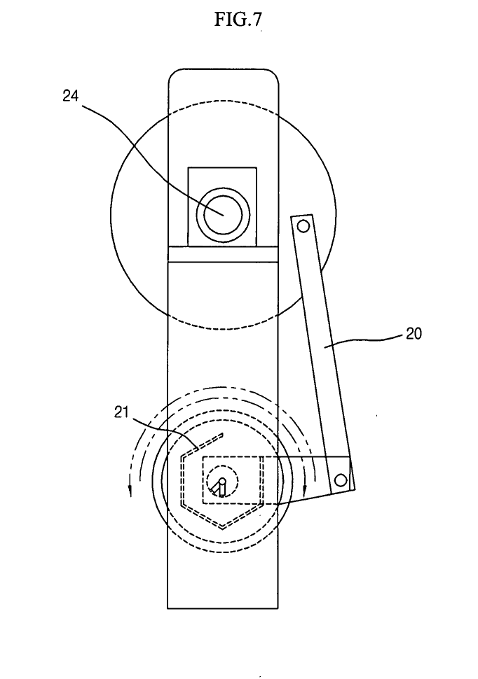

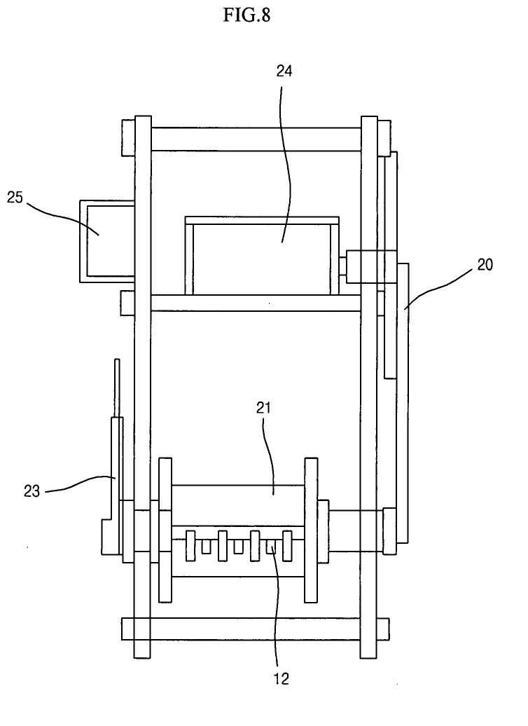

FIG. 7 is a side view showing an electroplating apparatus for use in an electroplating process using a mesh barrel rotating 200°, and FIG. 8 is a front view of the above apparatus.

According to the electroplating process using a mesh barrel, while a motor (24) is driven, a mesh barrel (21) connected to a cam shaft (20) of the motor is rotated in the range of 200° in right and left directions, and the rotation speed is controlled in the range of 1˜5 rpm using an rpm controlling switch (25) provided at one side of the electroplating apparatus. As such, the mesh barrel (21) connected to a cathode booth bar (23) is provided with bar-type danglers (12) and is structured in a manner such that one surface of the conventional sealed hexagonal barrel is open, and thus the plating solution introduced into such a barrel may be efficiently circulated.

The electroplating process is carried out under conditions of a cathode current density of 0.1˜10 A/dm², a plating solution temperature of 10˜30° C., a barrel rotation speed of 1˜10 rpm, and a plating speed of 0.2˜0.8 μm/min at a cathode current density of 1 A/dm².

On the plastic beads having the metal plating layer, the solder layer may be formed using the plating solution composed of any one selected from the group consisting of Sn/Pb, Sn/Ag, Sn, Sn/Cu, Sn/Zn, and Sn/Bi. Preferably, the solder layer may be formed of any one selected from the group consisting of 60˜70% Sn/30˜40% Pb, 96˜97% Sn/3˜4% Ag, Sn, Sn/0.7˜1.5% Cu, Sn/9% Zn, and Sn/3˜4% Bi.

Therefore, electroplating of conventional spherical plastic beads having an outer diameter of 1 mm or less causes problems such as a roughly electroplated surface, clotting of plastic beads having the nickel plating layer, and limitation of a plating thickness below 8 μm. However, in the case of using the improved electroplating process using a mesh barrel of the present invention, the thickness of the solder layer may be controlled in the range of 1˜100 μm on the plastic core beads having an outer diameter of 0.045˜1 mm, and the surface thereof is uniform.

The solder layer of the present invention is preferably an Sn/Pb alloy layer including 70% Sn/30˜40% Pb, and more preferably an alloy layer of 63% Sn/37% Pb, thereby reducing the amount of Pb compared to a conventional solder layer including Pb.

In addition, the solder layer is preferably a Sn/Ag alloy layer including 96˜97% Sn/3.0˜4.0% Ag, and more preferably an alloy layer of Sn/3.5% Ag.

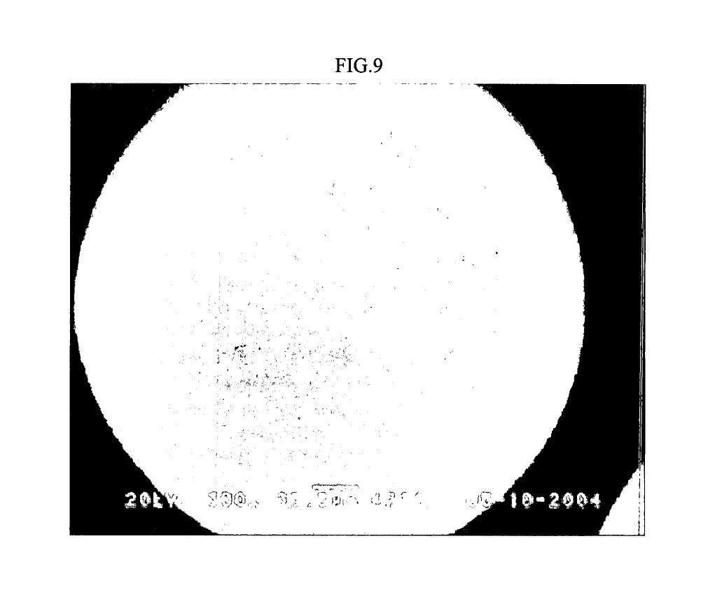

FIG. 9 is an SEM image showing the surface of the plastic conductive particles including the solder layer formed of Sn/3.5% Ag, in which the plastic conductive particles have an average diameter of 330˜370 μm and a uniform particle surface.

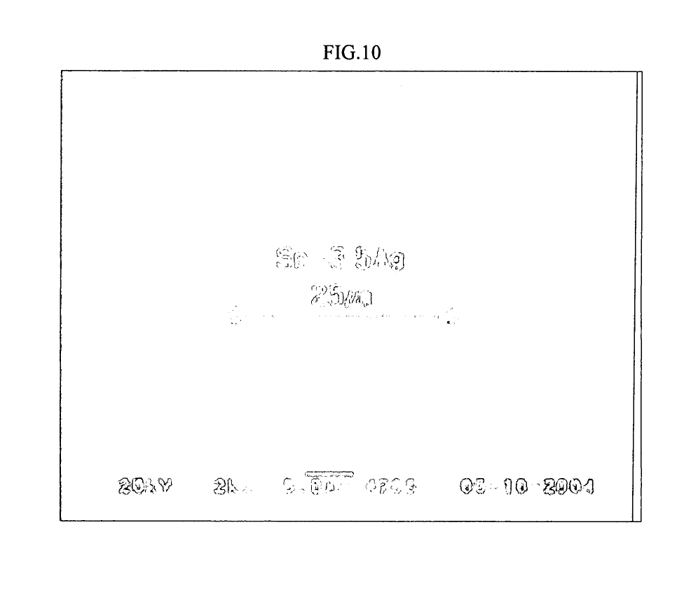

FIG. 10 is an SEM image showing the thickness of the Sn/Ag solder layer plated on the plastic conductive particles, in which the Sn/Ag solder layer is 25 μm thick

Hereinafter, the present invention is specifically explained using the following examples which are set forth to illustrate, but are not to be construed to limit the present invention

Manufacture of Plastic Core Beads

### EXAMPLE 1

### Step 1: Preparation of Nanoclay Composite

Into a reactor equipped with a stirrer, 100 parts by weight of styrene, 14.2 parts by weight of hydrophobized clay, and 476 parts by weight of acetonitrile were loaded and then allowed to react at 58° C. for 6 hours and at 70° C. for 6 hours, at 150 rpm, thus preparing a nanoclay composite. The first nanoclay composite thus prepared was washed several times with methanol and then dried in a vacuum.

Step 2: Manufacture of Plastic Core Beads having High Elastic Modulus of Compression

In a reactor equipped with a stirrer, 3.0 parts by weight of polyvinylalcohol based on ion exchange water was added to 400 parts by weight of ion exchange water based on a monomer and then dissolved therein while increasing the temperature of the reaction solution to 88° C. at 2° C./min at 300 rpm, thus preparing a first solution. Separately, in a beaker, 100 parts by weight of a polymerizable monomer comprising 17.5 wt % of divinylbenzene, 79.0 wt % of styrene and 3.5 wt % of the nanoclay composite was mixed with 0.4 parts by weight of benzoyl peroxide, and 0.2 parts by weight of t-butylperoxy-3,3,5-trimethylhexanoate and then stifed at room temperature for 2 hours, thus preparing a second solution. Subsequently, the second solution was added to the first solution and then allowed to react at 88° C. for 3 hours and at 95° C. for 5 hours, at 300 rpm. The final product was washed several times with methanol, dried in a vacuum, and then analyzed.

### EXAMPLE 2

Plastic core beads were manufactured in the same manner as in Example 1, with the exception that a polymerizable monomer comprising 30.0 wt % of divinylbenzene, 69.5 wt % of strene and 0.5 wt % of the nanoclay composite was used upon pipmtion of the second solution of Example 1.

### EXAMPLE 3

Plastic core beads were manufactured in the same manner as in Example 1, with the exception that a polymerizable monomer comprising 15.0 wt % of divinylbenzene, 80.5 wt % of styrene and 4.5 wt % of the nanoclay composite was used upon preparation of the second solution of Example 1.

### EXAMPLE 4

Plastic core beads were manufactured in the same manner as in Example 1, with the exception that a polymerizable monomer comprising 25.0 wt % of divinylbenzene, 73.5 wt % of syrene and 1.5 wt % of the nanoclay composite was used upon preparation of the second solution of Example 1.

### EXAMPLE 5

Plastic core beads were manufactured in the same manner as in Example 1, with the exception that a polymerizable monomer comprising 20.0 wt % of divinylbenzene, 77.0 wt % of strene and 3.0 wt % of the nanoclay composite was used upon preparation of the second solution of Example 1.

### COMPARATIVE EXAMPLE 1

Plastic core beads were manufactured in the same manner as in Example 1, with the exception that a polymerizable monomer comprising 0 wt % of divinylbenzene and 100 wt % of strene without the addition of the nanoclay composite was used upon preparation of the second solution of Example 1.

### COMPARATIVE EXAMPLE 2

Plastic core beads were manufactured in the same manner as in Example 1, with the exception that a polymerizable monomer comprising 30.0 wt % of divinylbenzene and 70.0 wt % of styrene without the addition of the nanoclay composite was used upon preparation of the second solution of Example 1.

The properties of the plastic core beads manufactured in Examples 1˜5 and Comparative Examples 1-2 are given in Table 1 below.

The thermal properties were measured using DSC and TGA. In addition, compressive fracture strength and elastic modulus of compression were measured using a micro-compression tester (MCT-W series), available from Shimadzu Co. Ltd.

TABLE 1

| | Ex. No. | | | | | C. Ex. No. | |
|---|---|---|---|---|---|---|---|
| | 1 | 2 | 3 | 4 | 5 | 1 | 2 |
| Clay (wt %) | 2.5 | 0.5 | 4.5 | 1.5 | 3.0 | 0 | 0 |
| Divinylbenzene (wt %) | 17.5 | 30.0 | 15.0 | 25.0 | 20.0 | 0 | 30.0 |
| Decomposition Temp. | 355 | 361 | 353 | 360 | 355 | 330 | 358 |
| (° C.) | | | | | | | |
| Tg | x | x | x | x | x | ∘ | x |
| (Whether detected or | | | | | | | |
| not) | | | | | | | |
| Compressive | 20.4 | 23.2 | 18.8 | 22.6 | 19.5 | 12.8 | 23.8 |
| Fracture Strength | | | | | | | |
| (kgf/mm²) | | | | | | | |
| Elastic Modulus | 470 | 410 | 520 | 430 | 480 | 330 | 380 |
| of Compression | | | | | | | |
| (kgf/mm²) | | | | | | | |

As is apparent from Table 1, the plastic core beads manufactured in Examples 1˜5 had a high elastic modulus of compression.

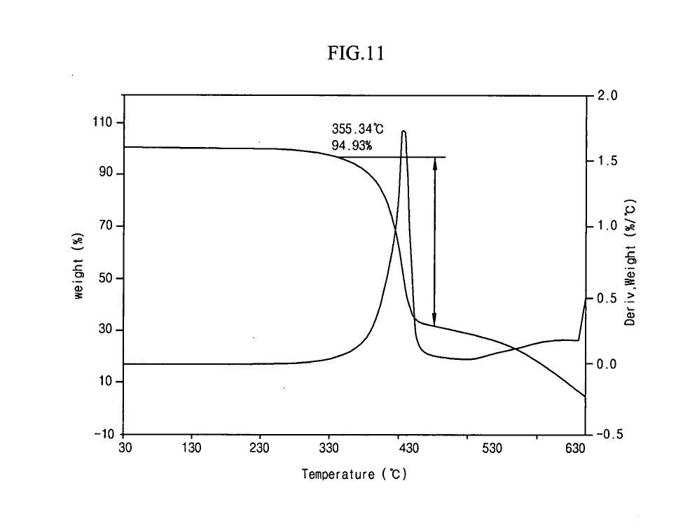

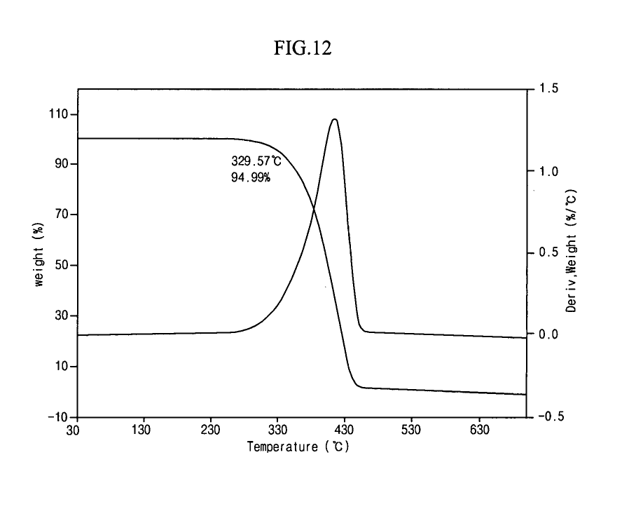

FIG. 11 shows the result of TGA of the plastic core beads manufactured in Example 1 of the present invention, in which 95% plastic core beads were present at 355.34° C. FIG. 12 shows the result of TGA of the plastic core beads manufactured in Comparative Example 1, in which 95% plastic core beads were present at 329.57° C. Thus, the plastic core beads of the present invention can be confirmed to have a 5% thermal decomposition tempatue of 330° C. or more, at which Tg or a melting temperature is not detected, and a high elastic modulus of compression 400˜550 kgf/mm².

2. Manufacture of Plastic Conductive Particles

### EXAMPLE 6

Step 1: The plastic core beads manufactured in any one of Examples 1˜5 were immersed in a degreasing solution comprising 15 g/L of NaOH and 50 g/L of a degreasing agent, degreased at 60° C. for 10 min. and then washed three times with water.

Step 2: The degreased plastic core beads were immersed in an etching solution comprising 150 g/L of chromic acid, 50 g/L of KMnO₄, 350 Ml of water and 100 Ml of sulfuric acid and then etched at 60˜90° C. for 1 hour with sting, thus providing concavo-convex path to the surfaces of the plastic core beads. Thereafter, the plastic core beads were washed four times with water, washed once with water containing 10 vol % of sulfuric acid, and then washed once with water.

Step 3: 1040 g of the etched plastic core beads were immersed in a mixture comprising 2˜6 g of SnCl₂, 15 Ml of hydrochloric acid, 200 Ml of water and 1 Ml of triton X-100 and then stirred at room temperature for 1 hour. Subsequently, the plastic core beads were washed three times with water, thus manufacturing plastic beads having Sn adsorbed thereon.

Step 4: The plastic beads having Sn adsorbed thereon were immersed in a mixture comprising 0.02˜0.05 g of PdCl₂, 1 Ml of hydrochloric acid, 500 Ml of water and 1 Ml of triton X-100, allowed to react at 60˜90° C. for 1 hour, washed once with water, washed with water containing 15 vol % of sulfuric acid with stirring for 10 min. and then washed three times with water, thus obtaining plastic beads having Pd adsorbed thereon.

Step 5: The plastic beads having Pd adsorbed thereon were immersed in a nickel plating solution comprising 2.5˜20 g of nickel sulfate, 2.5˜20 g of sodium acetate, 1.2˜10 g of maleic acid, 2.5˜20 g of sodium phosphite serving as a reducing agent, 100 ppm sodium thiosulfate, 0.5˜4 Ml of lead acetate, and 1˜8 Ml of triton X-100, and then electroless plated at 70˜90° C. for 1 hour. Thereafter, the plastic beads were washed three times with water, thus forming a 4 μm thick nickel plating layer.

Step 6: After the nickel plating process in step 5, the plastic beads having Pd adsorbed thereon were immersed in a copper plating solution of pH 9.5˜13.5 comprising 3.0˜15 g of copper sulfate, 3.5˜17 g of EDTA, 0.2˜200 mg of 2,2-bipyridine serving as a stabilizer, 0.1˜500 mg of PEG-1000 serving as a surfactant, and 2.0˜10 Mg of 37% formaldehyde serving as areducing agent, and then electroless plated at 20˜80° C. for 1 hour. Subsequently, the plastic beads were washed three times with water, thus forming a 6 μm thick copper plating layer.

Step 7: The plastic beads having the nickel plating layer and copper plating layer prepared in steps 5 and 6, respectively, were immersed in a plating solution of 63% Sn/37% Pb, and then mixed with 0.5 mm sized steel balls at a ratio of plastic beads to steel balls of 1:20. Thereafter, the electroplating process was conducted in a manner such that, using a cathode dangler having a bar-type cathode wire for improvement of electroplating, instead of a conventional lead wire-type cathode wire, the plating object was dispersed in a mesh barrel having the form of a sealed hexagonal barrel, the sealed hexagonal barrel was immersed in the electroplating solution, and then the mesh barrel was rotated in the range of 360° at 6˜10 rpm. Alternatively, the electroplating process was conducted by rotating the mesh barrel having a structure in which one surface of the conventional hexagonal barrel was open for efficient circulation of the plating solution introduced therein in an angle range of 200° in right and left directions. The electroplating process was carried out using the mesh barrel in order to efficiently circulate the plating solution As such, electroplating was performed under conditions of a cathode current density of 0.1˜10 A/dm², a plating solution temperature of 10˜30° C., a barrel rotation speed of 1˜10 rpm and a plating speed of 0.2˜0.8 μm/min at a cathode current density of 1 A/dm².

### EXAMPLE 7

The present example was conducted in the same manner as in Example 6, with the exception that the electroless plating step for formation of the copper plating layer of Example 6 was not conducted.

### EXAMPLE 8

The present example was conducted in the same manner as in Example 6, with the exception that a plating solution of Sn/3.5% Ag was used, instead of the plating solution of Sn/Pb in step 7 of Example 6.

### EXAMPLE 9

The present example was conducted in the same manner as in Example 6, with the exception that the electroless plating step for formation of the copper plating layer of Example 6 was not conducted and a plating solution of Sn/3.5% Ag was used, instead of the plating solution of SnPb in Example 6.

### EXAMPLE 10

The present example was conducted in the same manner as in Example 6, with the exception that a plating solution of Sn was used, instead of the plating solution of Sn/Pb in step 7 of Example 6.

### EXAMPLE 11

The present example was conducted in the same manner as in Example 6, with the exception that a plating solution of Sn/3.0% Bi was used, instead of the plating solution of Sn/Pb in step 7 of Example 6.

### EXAMPLE 12

The present example was conducted in the same manner as in Example 6, with the exception that a plating solution of Sn/0.7% Cu was used, instead of the plating solution of Sn/Pb in step 7 of Example 6.

### EXAMPLE 13

The present example was conducted in the same manner as in Example 6, with the exception that a plating solution of Sn/9% Zn was used, instead of the plating solution of Sn/Pb in step 7 of Example 6.

### INDUSTRIAL APPLICABILITY

As previously described herein,

First, the present invention provides novel plastic core beads having a nanoclay composite uniformly dispersed therein, with excellent thermal properties and a high elastic modulus of compression.

Second, the present invention provides spherical plastic conductive particles having an outer diameter of 1 mm or less, suitable for use in IC packaging of electronic apparatus, LCD packaging, or other conductive materials.

Third, the present invention provides a method of manufacturing plastic conductive particles having an outer diameter of 1 mm or less, comprising surface treating the core beads using an etching solution before electroplating, mining the obtained beads with 0.1 mm˜3.0 cm sized steel balls at a predetermined ratio to solve the problem of low density of the beads, and then electroplating the beads.

Fourth, the present invention provides a method of manufacturing the plastic conductive particles having an outer diameter of 1 mm or less via electroplating in a manner such that a mesh barrel having the form of a sealed hexagonal barrel is immersed in an electroplating solution and then rotated in the range of 360° at 6˜10 rpm, or a mesh barrel, having a structure in which one surface of the conventional sealed hexagonal barrel is open to efficiently circulate the plating solution introduced therein, is rotated in the range of 200° in right and left directions at 1˜5 rpm.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

We claim:

1. Plastic conductive particles, comprising:
plastic core beads having a high elastic modulus of compression of 400˜550 kgf/mm²;
a nickel plating layer formed to a thickness of 0.1˜10 μm on said plastic core beads; and
a solder layer formed to a thickness of 1˜100 μm on the nickel plating layer using any one selected from the group consisting of Sn/Pb, Sn/Ag, Sn, Sn/Cu, Sn/Zn, and Sn/Bi.

2. The particles according to claim 1, further comprising a copper plating layer formed to a thickness of 0.1˜10 μm on the nickel plating layer for providing nickel/copper plating layers.

3. The particles according to claim 1, wherein said particles are in spherical form and have an outer diameter of 2.5 μm to 1 mm.

4. The particles according to claim 1, wherein the plastic core beads are prepared by intercalating a polymerizable monomer into a layered structure of hydrophobized clay mineral for preparing a nanoclay composite substituted with the polymerizable monomer and then uniformly dispersing the nanoclay composite using a suspension polymerization process, thus having a 5% thermal decomposition temperature of 250˜350° C., while a glass transition temperature or a melting temperature is not detected in said temperature range, and a high elastic modulus compression of 400˜550 kgf/mm².

5. The particles according to claim 1, wherein the plastic core beads are polystyrene particles in which a nanoclay composite is uniformly dispersed.

6. The particles according to claim 1, wherein the plastic conductive particles have an outer diameter of 10 μm to 1 mm, comprising;
the plastic core beads having a high elastic modulus of compression of 400˜550 kgf/mm²;
the nickel plating layer formed to a thickness of 0.1˜10 μm on the beads; and
the solder layer formed to a thickness of 1˜100 μm including 60˜70% Sn/30˜40% Pb on the nickel plating layer.

7. The particles according to claim 1, wherein the plastic conductive particles have an outer diameter of 10 μm to 1 mm, said plastic conductive particles comprising;
the plastic core beads having a high elastic modulus of compression of 400˜550 kgf/mm²;
the nickel plating layer formed to a thickness of 0.1˜10 μm on the beads; and
the solder layer formed to a thickness of 1˜100 μm including 96˜97% Sn/3.0˜4.0% Ag on the nickel plating layer.

8. The particles according to claim 6, further comprising a copper plating layer formed to a thickness of 0.1˜10 μm on the nickel plating layer to provide nickel/copper plating layers.

9. A method of manufacturing plastic conductive particles, comprising the steps of:
preparing plastic core beads in which comprising a uniformly dispersed a nanoclay composite, said plastic core beads having a high elastic modulus of compression;
etching a surface of the plastic core beads for surface treatment thereof;
adsorbing Sn and Pd to the surface of the plastic core beads using a pretreatment solution containing SnCl₂ and a pretreatment solution containing PdCl₂;
forming a nickel plating layer to a thickness of 0.1˜10 μm using a nickel plating solution on the adsorbed bead surface for obtaining plastic beads;
mixing the plastic beads with 0.1 mm˜3.0 cm sized steel balls at a weight ratio of 1:2 to 1:20; and
electroplating the mixed plastic beads using an electroplating solution comprising any one selected from the group consisting of Sn/Pb, Sn/Ag, Sn, Sn/Cu, Sn/Zn, and Sn/Bi, to form for forming a solder layer.

10. The method according to claim 9, further comprising the step of forming a 0.1˜10 μm thick copper plating layer on the nickel plating layer using a copper plating solution, after the step of forming the nickel plating layer.

11. The method according to claim 9, wherein the step of etching a surface of the plastic core beads for surface treatment thereof comprises the step of immersing the plastic core beads in an etching solution composed mainly of 50˜300 g/L of chromic acid and 10˜100 g/L of potassium permanganate and etching the surfaces of the beads at 60˜90° C. for 1˜2 hours for surface treatment.

12. The method according to claim 9, wherein the pretreatment solutions are a pretreatment solution obtained by adding SnCl₂ to a composition comprising hydrochloric acid, water and a surfactant, and a pretreatment solution obtained by adding PdCl₂ to said composition.

13. The method according to claim 9, wherein the nickel plating layer is formed via electroless plating using a nickel plating solution comprising nickel sulfate, sodium acetate, maleic acid, sodium phosphite serving as a reducing agent, sodium thiosulfate and lead acetate serving as stabilizers, and triton X-100 serving as a surfactant.

14. The method according to claim 10, wherein the copper plating layer is formed via electroless plating using the copper plating solution comprising copper sulfate, EDTA, 2,2-bipyridine, formaldehyde serving as a reducing agent, and PEG-1000 serving as a surfactant.

15. The method according to claim 9, wherein the solder layer is formed of any one selected from the group consisting of 60˜70% Sn/30˜40% Pb, 96˜97% Sn/3˜4% Ag, Sn, Sn/0.7˜1.5% Cu, Sn/9% Zn, and Sn/3˜4% Bi.

16. The method according to claim 9, wherein the solder layer is formed a Sn/Pb alloy layer comprising 60˜70% Sn and 30˜40% Pb.

17. The method according to claim 9, wherein the solder layer is formed a Sn/Ag alloy layer comprising 96˜97% Sn and 3.0˜4.0% Ag.

18. The method according to claim 9, wherein the electroplating step comprises the step of dispersing the plastic beads using a cathode dangler having a bar-type cathode wire for improvement of electroplating in a mesh barrel having a form of a sealed hexagonal barrel, the hexagonal barrel being immersed in the electroplating solution, and then rotating the mesh barrel is rotated in a range of 360° at 6˜10 rpm.

19. The method according to claim 9, wherein the electroplating step comprises the step of dispersing the plastic beads using a cathode dangler having a bar-type cathode wire for improvement of electroplating in a mesh barrel having a structure in which one surface of a conventional sealed hexagonal barrel is open, and then rotating the mesh barrel in a range of 200° in right and left directions at 1˜5 rpm.

20. The method according to claim, further comprising the step of introducing the plating solution comprising any one selected from the group consisting of Sn/Pb, Sn/Ag, Sn, Sn/Cu, Sn/Zn, and Sn/Bi into the barrel.

21. The method according to claim 9, wherein the electroplating step is conducted under conditions of a cathode current density of 0.1˜10 A/dm², a plating solution temperature of 10˜30° C., a barrel rotation speed of 1˜10 rpm, and a plating speed of 0.2˜0.8 μm/min at a cathode current density of 1 A/dm².
